(19) United States
(12) Patent Application Publication
(10) Pub. No.: US 2026/0187013 A1
(43) Pub. Date: Jul. 2, 2026

(54) PROTOCOL ENHANCEMENTS FOR LOW LATENCY APPLICATIONS

(71) Applicants: Advanced Micro Devices, Inc., Santa Clara, CA (US); Xilinx, Inc., San Jose, CA (US)

(72) Inventors: Nitish Paliwal, Austin, TX (US); Mahesh UdayKumar Wagh, Austin, TX (US); Anil Kumar, Austin, TX (US); Amit P. Apte, Austin, TX (US); Xuanhua Li, Austin, TX (US); Vydhyanathan Kalyanasundharam, Santa Clara, CA (US); Kevin M. Lepak, Austin, TX (US); Kieran Mansley, Cambridge (GB); Jay Fleischman, Fort Collins, CO (US)

(73) Assignees: Advanced Micro Devices, Inc., Santa Clara, CA (US); Xilinx, Inc., San Jose, CA (US)

(21) Appl. No.: 19/006,047

(22) Filed: Dec. 30, 2024

(51) Int. Cl. G06F 13/42

(52) U.S. Cl. CPC G06F 13/4221; G06F 2213/0026

(57) ABSTRACT

Disclosed devices, systems, and methods may enhance communication protocols for low latency applications. Systems may include a device and a host interconnected by a high-performance interconnect and/or communication link. The device may comprise a transmitter, a receiver, and a control unit that may manage a credit-based flow control mechanism. In some aspects, the device may initiate a push write request, send a data header with an identifier (UQID) matching the push write request identifier (CQID), and transmit the data payload. The host may receive the push write request, match the UQID with the CQID, perform the write operation, and send a completion message back to the device. The method may involve ensuring sufficient credits before initiating the push write transaction, which may help prevent data loss and ensure reliable delivery. The push write mechanism may reduce the number of link traversals required for device-to-host memory writes, potentially lowering overall latency.

### BACKGROUND

Low latency applications may require extremely rapid data processing to capitalize on minute variations in time-sensitive information. These applications may benefit from rapid adaptation to events at sub-microsecond or nanosecond granularity. Specialized network adapters, system architectures, and high-performance interconnects, including those leveraging Compute Express Link (CXL), have evolved to address latency differentiation needs. However, existing protocols, including CXL, utilize certain semantics that introduce latency in device-to-host memory writes.

Current solutions necessitate multiple link traversals to complete a memory write transaction, resulting in increased latency. The inefficiency of the existing mechanism in quickly pushing data from the device to the host impacts the performance of software reliant on timely memory writes. There is a need for protocol enhancements within high-performance interconnects (e.g., CXL) that reduce the number of link traversals required for device-to-host memory writes, thereby lowering overall latency and improving software performance.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 shows a system diagram of a device and a host interconnected by a high-performance interconnect, illustrating the components involved in the push write mechanism.

FIG. 2 is a flowchart of an example method for device operations for improving low latency operations.

FIG. 3 illustrates a block diagram of a credit-based flow control mechanism between a device and a host in a high-performance interconnect.

FIG. 4 is a flowchart of a method for host operations for improving low latency operations.

FIG. 5 shows a sequence diagram illustrating the process of a push write request between a device and a host.

FIG. 6 shows a detailed block diagram of a system implementing push write transactions, including components of a device and a host connected via a high-performance interconnect, and illustrating the data structures and management units involved in the push write mechanism.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION

The present disclosure generally relates to protocol enhancements designed to improve the efficiency and performance of device-to-host memory writes, particularly for latency-sensitive applications such as High-Frequency Trading (HFT). Traditional memory write mechanisms often suffer from high latency due to multiple link traversals, which limit the responsiveness of latency-critical operations. To address this challenge, embodiments of the present disclosure introduce a push write mechanism that allows a device to initiate a write request and transmit a data payload to the host without waiting for a command. By significantly reducing the number of link traversals required to complete a memory write transaction, this mechanism lowers overall latency and improves system performance. Central to the mechanism are unique identifiers, the Command Queue Identifier (CQID) and Unique Queue Identifier (UQID), which ensure precise matching of data payloads with corresponding write requests, thereby maintaining data integrity.

This technical solution incorporates several key components and operations. An example device may include a control unit that manages a credit-based flow control mechanism to ensure that sufficient credits are available before initiating a push write transaction. A device transmitter may send a push write request, data header, and data payload to the host. The host, in turn, uses a control unit to match the CQID with the UQID, perform the write operation, and send a completion message back to the device. This completion message confirms whether the write operation has been globally observed, allowing the device to free up memory resources associated with the transaction. In some aspects, the device may deallocate memory by releasing buffers or data structures that were used to store information about the push write request. The device may also recycle identifiers like the CQID and UQID, making them available for use in future transactions. Identifier recycling may refer to the process of returning used identifiers to a pool of available identifiers that can be reused for subsequent operations. This memory deallocation and identifier recycling may help optimize resource utilization and enable the device to efficiently handle subsequent push write operations.

By enabling reliable communication and preventing data loss, this mechanism ensures robust performance in latency-sensitive environments. Although described in the context of the CXL standard, the push write mechanism and its supporting features may be applicable to other high-performance interconnect protocols facing similar latency challenges.

The push write mechanism reduces latency by allowing devices to send data without waiting for host commands, minimizing delays and improving data processing speed. This is particularly advantageous for latency-sensitive applications, where rapid memory write operations are critical, such as HFT, real-time analytics, and data-intensive simulations. The credit-based flow control mechanism further ensures reliable data delivery by regulating the flow of data between the device and the host. Together, these features address inefficiencies in existing protocols and enhance the performance of high-speed data transfers.

While this disclosure focuses on enhancements within the CXL standard, including the CXL.Cache protocol, these principles and mechanisms are equally relevant to other high-performance interconnect systems such as PCIe and NVLink, which face similar latency challenges. High-performance interconnects are integral to data center hardware, enabling high-speed communication between CPUs, memory, and accelerators such as GPUs and FPGAs. By facilitating low-latency operations and maintaining cache coherence, these systems ensure efficient and scalable data transfers. The proposed enhancements are designed to address latency bottlenecks across such protocols, making them widely applicable to modern computing environments.

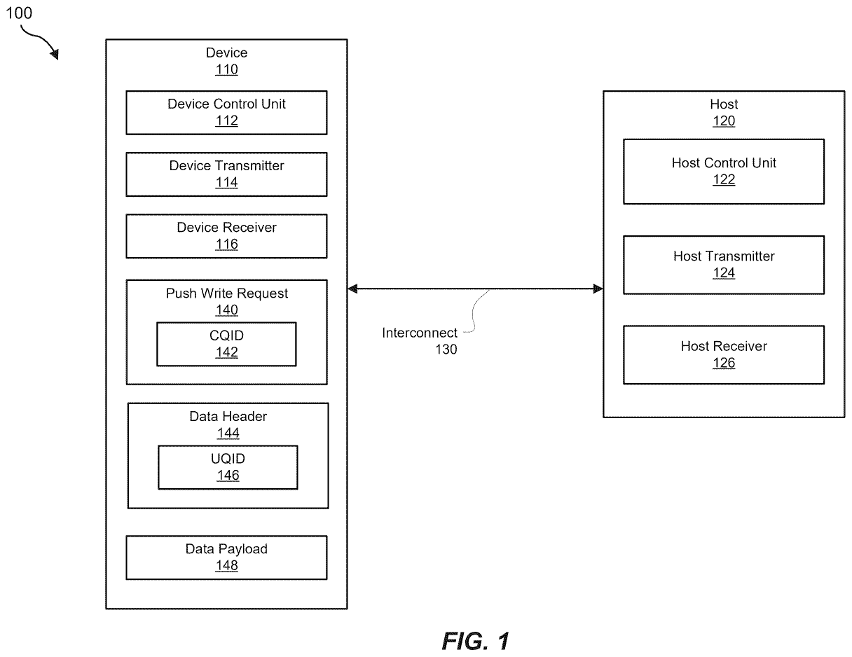

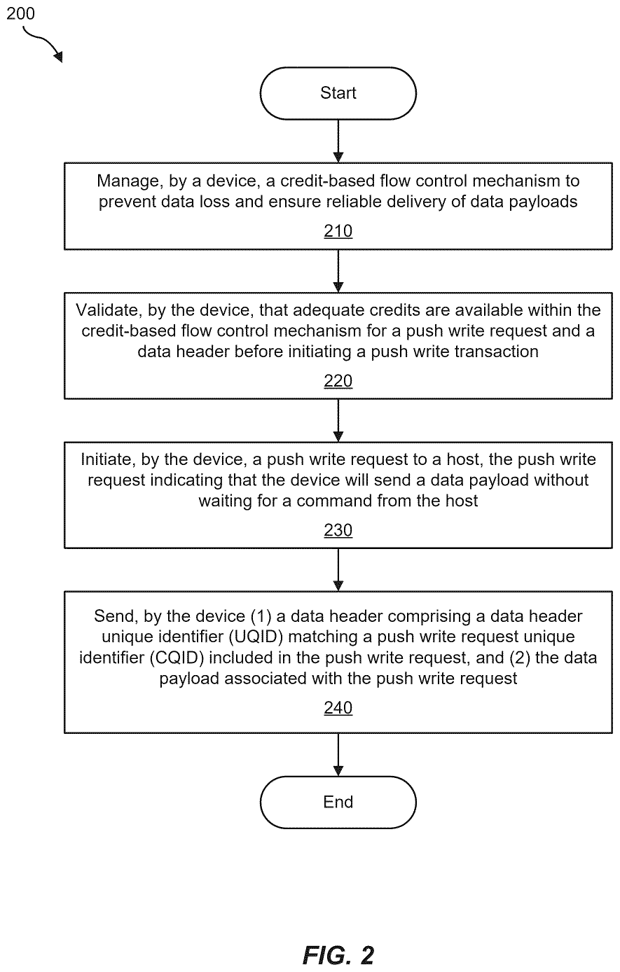

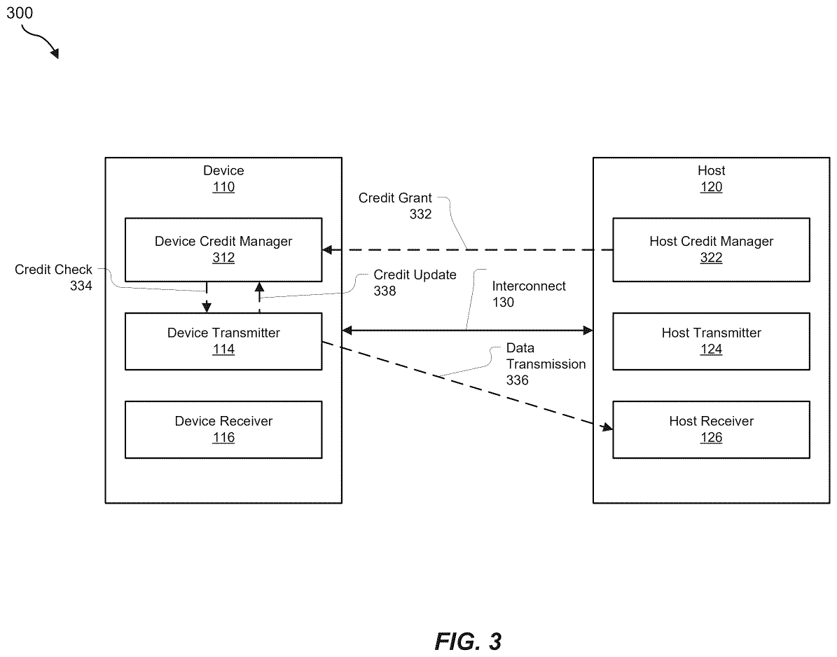

The following will describe, in relation to FIGS. 1 and 4-6, various devices and systems that may enhance protocols for low-latency operations in high-performance interconnects (e.g., the CXL.Cache protocol) for low latency operations. Additional methods will be described in relation to FIGS. 2 and 3.

FIG. 1 shows an example system 100 that includes a device 110 and a host 120, interconnected by a high-performance interconnect 130 (“interconnect 130” in FIG. 1 and FIG. 3). The device 110 comprises a device control unit 112, a device transmitter 114, and a device receiver 116. The host 120 comprises a host control unit 122, a host transmitter 124, and a host receiver 126.

The device control unit 112 manages the operations of the device 110, including the initiation of push write requests. The device transmitter 114 is configured to send push write requests, data headers, and data payloads to the host 120. The device receiver 116 is configured to receive completion messages from the host 120, indicating whether the write operations have been globally observed.

In some examples, a “completion message” includes or refers to a communication sent from a host to a device after a push write operation has been executed and globally observed. The completion message indicates whether the write operation was successful or if an error occurred. In some embodiments, the completion message may include an error indication if an error condition is detected during the write operation. The completion message serves as an acknowledgment to the device that the push write transaction has been fully processed by the host, allowing the device to deallocate memory associated with the transaction and recycle identifiers such as the CQID and UQID.

An “external completion message” may refer to a completion message that is sent as a separate and distinct communication from the host to the device, independent of the initial push write request and data payload transmission. The external nature of this message emphasizes its role in providing clear and unambiguous feedback about the status of the write operation, enabling the device to take appropriate actions based on the success or failure of the transaction.

As used herein, “globally observed” refers to the state of a write operation in a distributed computing system where the written data has been fully executed, acknowledged, and made visible across all relevant components of the system. This includes, but is not limited to, all caches, memory controllers, and coherent agents within the system. A write operation is considered globally observed when (1) the data has been successfully written to the target memory location; (2) l caches in the system have either invalidated or updated their copies of the affected memory location; (3) all pending transactions related to the affected memory location have been completed or appropriately handled; and/or (4) the updated data is guaranteed to be visible to any subsequent read operations from any component in the system.

In the context of the push write mechanism described herein, a write operation being globally observed ensures that the data sent by the device has been fully integrated into the host's memory system, maintaining data consistency and coherence across the entire system before the completion message is sent back to the device.

Likewise, the host control unit 122 manages the operations of the host 120, including the processing of incoming push write requests. The host transmitter 124 is configured to send completion messages back to the device 110. In some examples, the completion message may include an error indication if an error condition is detected during the write operation. The host receiver 126 is configured to receive push write requests, data headers, and data payloads from the device 110.

As used herein, the term “push write request” refers to a type of memory write operation where a device initiates a write request and sends a data payload to a host without waiting for a command from the host. In some aspects, a push write request may include a unique identifier, such as a CQID, to track and manage the transaction. The push write request may be followed immediately by a data header and a data payload, potentially reducing the number of link traversals required to complete the memory write transaction. As used herein, the term “data header” refers to metadata that precedes the actual data payload and may contain information such as a UQID to help associate the incoming data with its corresponding request. The term “data payload” refers to the actual data being transmitted as part of the push write request. In some cases, push write requests may be used in high-performance interconnect protocols to lower overall latency and improve system performance for latency-sensitive applications. Push write requests may be particularly useful in scenarios where rapid memory write operations are important, such as in HFT, real-time analytics, and data-intensive simulations.

The high-performance interconnect 130 facilitates high-speed communication between the device 110 and the host 120, enabling low-latency data transfers. This link supports the push write mechanism, allowing the device 110 to send data to the host 120 without waiting for a command from the host 120, thereby reducing the number of link traversals required to complete a memory write transaction. In some embodiments, high-performance interconnect 130 may be a CXL communication link.

In some implementations, the device 110 may be a network interface card (NIC), a storage controller, or an accelerator such as a GPU or FPGA. The device control unit 112 may include a microcontroller or a dedicated hardware logic circuit designed to manage the push write operations and credit-based flow control. The device transmitter 114 and device receiver 116 may be implemented using high-speed serial interfaces capable of handling the data rates required by the CXL protocol.

The host 120 may be a central processing unit (CPU) or a memory controller within a server or data center environment. The host control unit 122 may include a microcontroller, a system-on-chip (SoC), or a dedicated hardware logic circuit designed to manage the reception and processing of push write requests. The host transmitter 124 and host receiver 126 may also be implemented using high-speed serial interfaces compatible with the CXL protocol.

The high-performance interconnect 130 may be implemented using high-speed interconnect technologies such as PCIe (Peripheral Component Interconnect Express) physical layers, with additional protocol layers to support CXL-specific features. The link may support multiple lanes to provide the necessary bandwidth for low-latency data transfers. In some implementations, the high-performance interconnect 130 may also support error detection and correction mechanisms to ensure data integrity during transmission.

Additional features of the device 110 and host 120 may include support for various high-performance interconnect protocol versions and extensions, allowing for backward compatibility and future upgrades. The device control unit 112 and host control unit 122 may also include firmware or software components that can be updated to support new features or optimizations (e.g., in the CXL protocol).

As shown, device 110 may include and/or generate a push write request 140 that may include a CQID 142. Push write request 140 may include or represent a type of memory write operation where a device initiates the write request and sends the data payload to the host without waiting for a command from the host. Embodiments of the present disclosure may reduce a number of link traversals required to complete the memory write transaction, thereby lowering overall latency and improving performance for latency-sensitive applications. A CQID, such as CQID 142, may include a unique identifier used by a device to tag each transaction in progress, ensuring that the host can correctly associate incoming data payloads with their corresponding write requests.

As also shown, device 110 may also include or generate a data header 144 that may include a UQID 146. Data header 144 may include or represent a segment of metadata that precedes the actual data payload in a communication or data transfer process. It may contain information such as unique identifiers (e.g., a UQID 146) that may help the receiving system correctly associate the incoming data payload with its corresponding request, ensuring data integrity and proper transaction management. In the context of the CXL.Cache protocol enhancements described herein, data header 144 may be transmitted immediately following a push write request (e.g., push write request 140) and includes identifiers that match those in the request to facilitate efficient and reliable data processing by the host. A UQID, such as UQID 146, may include or represent a matching identifier included in the data header, which the host uses to match the data payload with the initial push write request.

As further shown in FIG. 1, device 110 may also include, store, maintain, access, generate, and/or transmit a data payload 148. A data payload is the actual data being transmitted in a communication or data transfer process, sometimes excluding metadata or control information. In the context of the CXL.Cache protocol enhancements described herein, data payload 148 may refer to specific data that device 110 sends to host 120 as part of a push write request (e.g., push write request 140). The data payload may be transmitted immediately following the data header (e.g., data header 144) and is associated with the push write request through matching identifiers (CQID 142 and UQID 146) to ensure that host 120 can correctly process and store the data in the appropriate location.

In some examples, data payload may have a size of 64 bytes, which may correspond to a full cache line in many modern computing architectures. This size selection may ensure that the data payload aligns with cache line boundaries, facilitating efficient memory operations and reducing the likelihood of cache line splits. By transmitting a full cache line, the system can optimize the data transfer process, minimizing the overhead associated with partial writes and ensuring that the entire cache line is updated in a single transaction.

Additionally, the use of a 64-byte data payload may also align with the credit-based flow control mechanism employed by some embodiments of the present disclosure. Device 110 may manage available credits, ensuring that sufficient credits are available to handle the push write request and the associated data payload. By standardizing the data payload size to 64 bytes, the system can more accurately predict and manage the credit requirements, preventing data loss and ensuring reliable delivery of data payloads.

FIG. 2 is a flowchart of an example method 200 for device operations for improving low latency operations. At step 210, one or more of the systems described herein (e.g., device control unit 112 and/or host control unit 122) may manage a credit-based flow control mechanism to prevent data loss and ensure reliable delivery of data payloads.

A credit-based flow control mechanism may refer to a method used in data communication systems to manage the rate of data transmission between a sender and a receiver. This mechanism may help prevent data loss and buffer overflow by coordinating the flow of data packets based on available credits. In some aspects, the sender may be allocated a certain number of credits, with each credit representing permission to transmit a unit of data. As the sender transmits data, it may consume credits. The receiver may replenish credits as it processes received data. This approach may ensure that the receiver can handle the incoming data without being overwhelmed, potentially enabling reliable delivery by matching the transmission rate to the receiver's processing capacity.

The systems described herein may perform step 210 in a variety of ways. In one example, the device control unit 112 may be responsible for managing the credit-based flow control mechanism on the device side. This may involve several key steps. First, at the start of a communication session, the device control unit 112 may initialize one or more credit counters. These counters may represent a number of data packets or payloads that the device is allowed to send to the host without receiving additional credits.

Next, the device control unit 112 may continuously monitor the available credits. Before initiating a push write request, the control unit may check the current credit count to ensure that there are sufficient credits available to send the data header and data payload. This may prevent the device from overwhelming the host with more data than it can handle. Each time the device sends a data packet or payload, the device control unit 112 may decrement the credit counter by an appropriate amount. This may ensure that the credit count accurately reflects the remaining capacity for data transmission. When the available credits fall below a certain threshold, the device control unit 112 may send a credit request to the host. This request may prompt the host to grant additional credits, allowing the device to continue sending data without interruption. If the device control unit 112 detects that the available credits have been exhausted, it may temporarily halt data transmission. This flow control enforcement may prevent data loss and buffer overflow by ensuring that the device does not send more data than the host can process.

In some examples, the host control unit 122 may be responsible for managing a credit-based flow control mechanism on the host side. This may involve several steps. The host control unit 122 may periodically grant credits to the device. These credits may represent the host's capacity to receive and process data packets or payloads. The control unit may determine a number of credits to grant based on a variety of factors, such as, without limitation, the host's current buffer availability and/or processing capacity.

The host control unit 122 may keep track of the credits it has granted to the device (and/or one or more additional devices connected to the high-performance interconnect system), while also accounting for the number of credits initialized in the device's credit counters as described above. This may ensure that the host maintains an accurate credit count throughout the transaction. Failure to consider the initialized credits from the device may result in an underflow of the credit counter, leading to data flow inconsistencies. Each time the host receives a data packet or payload, the control unit may decrement the corresponding credit counter. This may ensure that the credit count accurately reflects the remaining capacity for data reception.

The host control unit 122 may manage the host's data buffers, ensuring that there is sufficient space to accommodate incoming data packets or payloads. The control unit may dynamically adjust the buffer allocation based on the current data flow and processing requirements. If the host control unit 122 detects that the host's buffers are nearing capacity, it may temporarily stop granting additional credits to the device. This flow control feedback mechanism may reduce or prevent buffer overflow(s) and may ensure that the host can process the received data without loss. In the event of an error condition, the host control unit 122 may send an error indication to the device. This indication may be included in the completion message, informing the device of the error and allowing it to take appropriate corrective actions.

By managing the credit-based flow control mechanism, the device control unit 112 and/or host control unit 122 may work together to prevent data loss and to ensure reliable delivery of data payloads. The device control unit 112 may ensure that data transmission is regulated based on available credits, while the host control unit 122 may manage buffer availability and provides feedback to maintain a balanced data flow. This coordinated approach may ensure efficient and/or reliable communication between the device and host, addressing the technical challenges associated with high-speed data transfers in latency-sensitive applications.

By way of illustration, FIG. 3 illustrates an example system 300 that includes a device credit manager 312 included as part of (e.g., a function of device control unit 112) device 110 and a host credit manager 322 included as part of (e.g., a function of host control unit 122) host 120. This figure illustrates some operations of a credit-based flow control mechanism as described above.

The device credit manager 312 is responsible for managing the credit-based flow control mechanism on the device side. This involves performing a credit check 334 to ensure that sufficient credits are available before initiating a push write transaction. The device credit manager 312 communicates with the host credit manager 322 to request additional credits when necessary. The host credit manager 322 evaluates the request and grants additional credits through a credit grant 332, which is sent back to the device credit manager 312.

Once the device credit manager 312 confirms that there are sufficient credits, the device transmitter 114 initiates the push write transaction by sending a data transmission 336 to the host 120. The data transmission 336 includes the push write request, data header, and data payload. The host receiver 126 captures the incoming data transmission and forwards the data transmission 336 to the host credit manager 322 for processing.

After performing the write operation and ensuring that the write operation has been globally observed, the host credit manager 322 sends a completion message back to the device receiver 116. This completion message indicates whether the write operation was successful or if an error occurred.

The device credit manager 312 updates the credit count based on the completion message received from the host 120. This credit update 338 ensures that the credit count accurately reflects the remaining capacity for data transmission. If the available credits fall below a certain threshold, the device credit manager 312 may send another credit request to the host credit manager 322 to obtain additional credits.

Returning to FIG. 2, at step 220, one or more of the systems described herein may validate that adequate credits are available within the credit-based flow control mechanism for the push write request and the data header before initiating a push write transaction. For example, at the start of a communication session, device control unit 112 may initialize one or more credit counters. These counters may represent a number of data packets or payloads that the device is permitted to send to the host without receiving additional credits. The initialization process may set the credit counters to a predefined value based on the host 120 capacity to receive and process data. Validating adequate credits may involve comparing the current credit count to a threshold value required for the push write transaction. If the available credits meet or exceed this threshold, the transaction may proceed. Otherwise, the device may request additional credits from the host before continuing.

Device control unit 112 may continuously monitor the available credits. This may involve keeping track of the current credit count and ensuring that it accurately reflects the remaining capacity for data transmission. Device control unit 112 may periodically check the credit counters to determine a number of credits available for sending data packets or payloads.

Before initiating a push write request, device control unit 112 may perform a credit check to ensure that there are sufficient credits available to handle both the push write request and the associated data header. This may involve comparing the current credit count with the required number of credits for the transaction. If the available credits are sufficient, the control unit proceeds with the push write transaction. If not, it takes appropriate actions to obtain additional credits.

When the available credits fall below a certain threshold, the device control unit 112 may send a credit request to host 120. This request may prompt host 120 to grant additional credits, allowing device 110 to continue sending data without interruption. The credit request may include information about the current credit count and the number of additional credits needed to proceed with the push write transaction.

Upon receiving a credit request from device 110, host control unit 122 may evaluate the request and may grant additional credits based on a current buffer availability and/or processing capacity of host 120. Host control unit 122 may update its credit counters to reflect the granted credits and sends a credit grant message back to the device. This message may include a number of additional credits granted to device 110.

Upon receiving a credit grant message from host 120, device control unit 112 may update its credit counters to reflect the additional credits. This may ensure that the credit count accurately represents the remaining capacity for data transmission. Device control unit 112 may then re-evaluate the available credits to determine if they are sufficient to proceed with the push write transaction.

If device control unit 112 detects that the available credits have been exhausted, it may temporarily halt data transmission. This flow control enforcement may prevent data loss and buffer overflow by ensuring that device 110 does not send more data than host 120 can process. Device control unit 112 may wait for additional credits to be granted before resuming data transmission.

Once device control unit 112 confirms that there are sufficient credits available, it may initiate the push write transaction. As used herein, the term “push write transaction” refers to a data transfer operation where a device initiates a write request and sends a data payload to a host without waiting for a command from the host, potentially reducing latency by minimizing the number of link traversals required to complete the memory write operation. Initiating the push write transaction may involve sending the push write request, data header, and data payload to host 120. Device control unit 112 may ensure that the transaction proceeds smoothly by continuously monitoring the credit count and requesting additional credits as needed.

By following these steps, device control unit 112 may ensure that there are sufficient credits within the credit-based flow control mechanism to handle the push write request and data header before initiating a push write transaction. This coordinated approach may prevent data loss, ensure reliable delivery of data payloads, and may maintain efficient and reliable communication between the device and host.

Returning to FIG. 2, at step 230, one or more of the systems described herein may initiate a push write request to a host. As mentioned above, a push write request is a type of memory write operation initiated by a device to write data to a host's memory without waiting for a command from the host. This mechanism may reduce latency by minimizing the number of link traversals required to complete the memory write transaction. A push write request may include a unique CQID, which is used to track and manage the transaction.

As described above, before initiating a push write request, device control unit 112 may check the available credits within the credit-based flow control mechanism. This may involve verifying that there are sufficient credits to handle both the push write request and the associated data header. If the available credits are insufficient, the device requests additional credits from the host. Once sufficient credits are confirmed, the device generates a push write request. This request includes the CQID, which uniquely identifies the transaction. The device transmits the push write request to the host over high-performance interconnect 130. This request is sent without waiting for a command or acknowledgment from the host, which helps to reduce the overall latency of the transaction.

At step 240, one or more of the systems described herein may send (1) a data header that includes a UQID matching the push write request CQID included in the push write request, and (2) the data payload associated with the push write request. For example, immediately following the push write request, device 110 may prepares a data header. The data header may contain metadata about the data payload that will follow. The data header may include UQID that matches the CQID from the push write request. This matching may ensure that host 120 can correctly associate the data payload with the corresponding push write request.

Device 110 may then transmit the data header to host 120 over high-performance interconnect 130. High-performance interconnect 130 facilitates high-speed communication between device and host, enabling low-latency data transfers. The data header may be sent over an independently credited physical channel, ensuring that the transmission is efficient and reliable. An independently credited physical channel is a communication pathway within a system that operates under a credit-based flow control mechanism, where credits are used to manage and regulate the transmission of data packets. Each channel is assigned its own set of credits, which ensures that data can be sent independently and efficiently without overwhelming the receiver.

After the data header is sent, device 110 may prepare the data payload. As mentioned above, the data payload (e.g., data payload 148) is the actual data that the device intends to write to the host's memory. The data payload is associated with the push write request and data header through the matching CQID and UQID. This association ensures that host 120 can correctly process and store the data in the appropriate location.

Device 110 may then transmit the data payload to host 120 over high-performance interconnect 130. Similar to the data header, the data payload is sent over an independently credited physical channel. This ensures that the data payload is transmitted efficiently and reliably, without interference from other data transmissions.

Upon receiving the data header and data payload, host 120 may use the matching CQID and UQID to correctly associate the data payload with the push write request. Host control unit 122 may match the CQID from the push write request with the UQID in the data header, ensuring that the data payload is correctly linked to the corresponding transaction.

Host 120 then performs the write operation, storing the data payload in its memory. After the write operation is completed and globally observed, host 120 sends a completion message back to device 110. The write operation being completed and globally observed means that the data write to the host's memory has been fully executed and acknowledged by all relevant components in the system, ensuring that the data is visible and accessible across the entire system. This guarantees that the write has been successfully propagated and recognized by all caches and memory controllers, maintaining data consistency and coherence. The completion message indicates whether the write operation was successful or if an error occurred. If an error is detected, the completion message includes an error indication, allowing device 110 to take appropriate corrective actions.

The completion message may be considered “external” in the context of the CXL.Cache protocol enhancements described herein due to the role in communicating the status of a write operation from the host to the device. The term “external” refers to the fact that the completion message is sent from the host to the device as an independent and distinct communication, separate from the initial push write request and data payload transmission. This external completion message serves as a confirmation that the write operation has been globally observed, ensuring that the data has been successfully written to the host's memory and acknowledged by all relevant components in the system.

In the described system, the host generates the external completion message after performing the write operation and verifying that the write has been globally observed. This message is then transmitted back to the device over the high-performance interconnect. The external nature of the completion message allows the host to provide feedback to the device regarding the success or failure of the write operation, including any error conditions that may have been detected. By sending this completion message as a separate communication, the system ensures that the device receives a clear and unambiguous indication of the write operation's status, enabling the device to take appropriate actions, such as deallocating memory and recycling the CQID and UQID.

The external completion message is a component of the push write mechanism, as the external completion message provides the confirmation to the device that the data has been correctly written and observed. This external communication ensures that the device can maintain data integrity and consistency, even in the presence of potential errors or other issues that may arise during the write operation. By utilizing an external completion message, the system enhances the reliability and robustness of the CXL.Cache protocol, enabling efficient and low-latency data transfers between the device and the host.

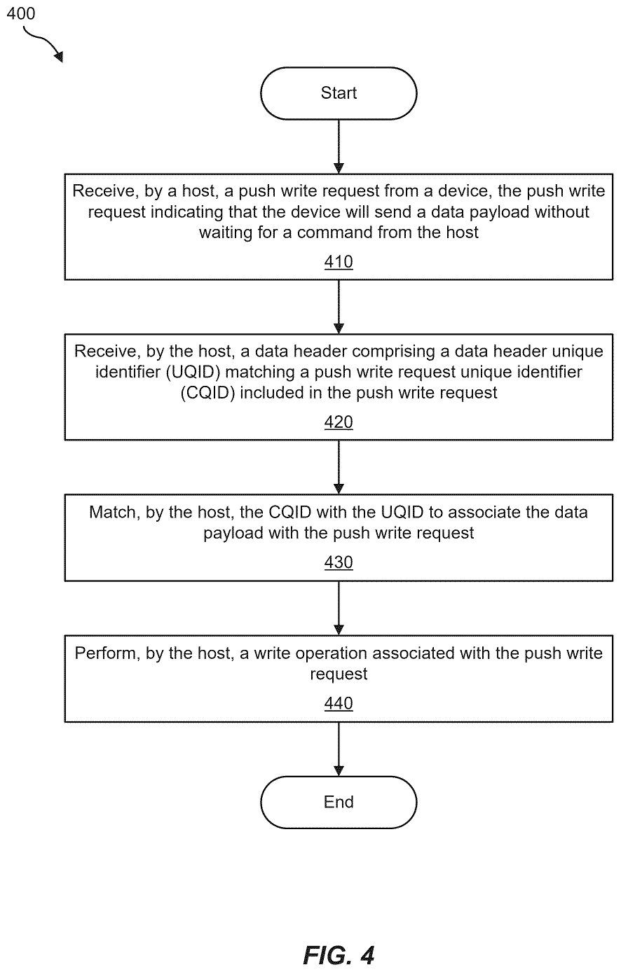

FIG. 4 is a flowchart of an example method 400 for host operations for improving low latency operations. At step 410, one or more of the systems described herein (e.g., device 110, host 120, etc.) may receive a push write request. As mentioned above, the push write request indicating that the device will send a data payload without waiting for a command from the host. For example, as described above, host 120 may receive a push write request from device 110 via high-performance interconnect 130. Upon receiving the push write request, host receiver 126 captures the incoming request. Host receiver 126 is responsible for receiving data transmissions from device 110 and ensuring that they are correctly processed by host control unit 122. Host control unit 122 then processes the push write request. It uses the CQID included in the push write request to track and manage the transaction, ensuring that the data payload can be correctly associated with the corresponding write request.

At step 420, one or more of the systems described herein (e.g., device 110, host 120, etc.) may receive a data header that may include a UQID matching a CQID included in the push write request. For example, host 120 may receive a data header that may include a UQID matching a CQID included in the push write request. Host 120 may receive the data header in a variety of contexts. For example, host receiver 126 may capture the incoming data header and may forward it to host control unit 122.

At step 430, one or more of the systems described herein (e.g., device 110, host 120, etc.) may match the CQID with the UQID to associate the data payload with the push write request. For example, host 120 may match the CQID with the UQID to associate the data payload with the push write request. Host control unit 122 may use the matching CQID and UQID to correctly associate the data payload with the push write request, ensuring that the data is correctly processed and stored in the appropriate location.

At step 440, one or more of the systems described herein (e.g., device 110, host 120, etc.) may perform a write operation associated with the push write request. For example, host 120 may perform a write operation associated with the push write request by storing the data payload in a memory or a storage device.

In some examples, the write operation may include a Weakly-Ordered-Write-Invalidate-Forward (WOWrInvFD) request. A WOWrInvFD request is a specific type of memory write operation designed to optimize data transfer efficiency and reduce latency. In this context, it may allow a device to initiate a write request and send the data payload to the host without waiting for a command from the host. The “weakly ordered” aspect indicates that the write operations do not strictly adhere to a specific order, which can further enhance performance by allowing more flexible data handling. The “invalidate-forward” component ensures that any previous data in the cache is invalidated, and the new data is forwarded, maintaining data consistency across the system.

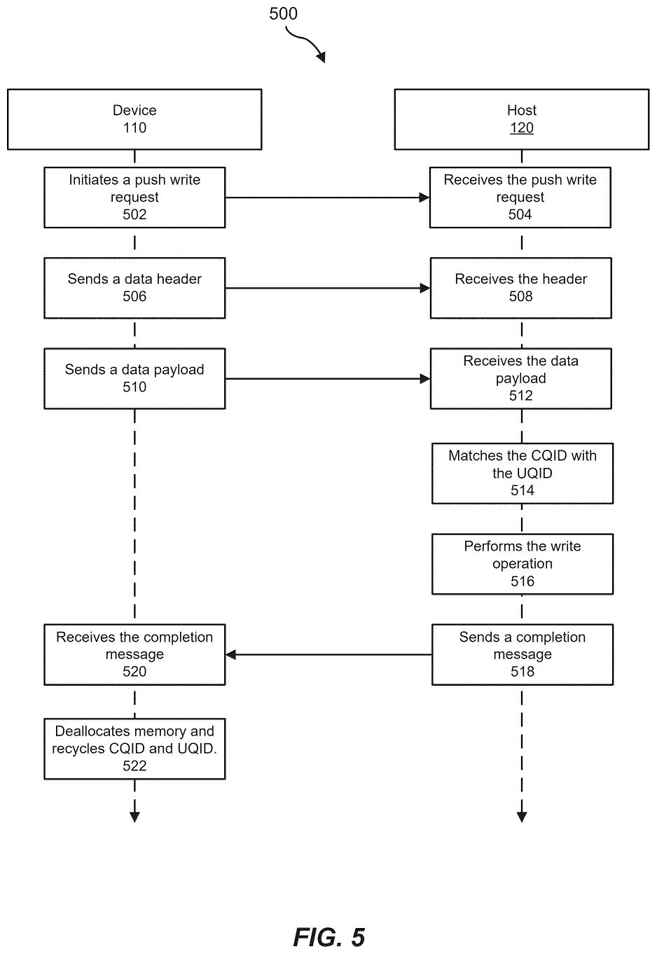

FIG. 5 shows a sequence diagram 500 that illustrates a push write request process between a device 110 and a host 120. The sequence diagram 500 outlines the steps involved in initiating and completing a push write transaction, highlighting the interactions between the device 110 and the host 120.

At operation 502, the device 110 initiates a push write request. This request indicates that the device 110 will send a data payload to the host 120 without waiting for a command from the host 120. The push write request includes a CQID that identifies the transaction.

At operation 504, the host 120 receives the push write request. The host 120 captures the incoming request and processes the incoming request using the CQID to track and manage the transaction.

At operation 506, the device 110 sends a data header to the host 120. The data header includes a UQID that matches the CQID from the push write request. This matching ensures that the host 120 can correctly associate the data payload with the corresponding push write request.

At operation 508, the host 120 receives the data header. The host 120 captures the incoming data header and processes the data header to prepare for the data payload.

At operation 510, the device 110 sends the data payload to the host 120. The data payload is the actual data that the device 110 intends to write to the host's memory. The data payload is associated with the push write request and data header through the matching CQID and UQID.

At operation 512, the host 120 receives the data payload. The host 120 captures the incoming data payload and processes the data payload using the matching CQID and UQID to correctly associate the data payload with the push write request.

At operation 514, the host 120 matches the CQID with the UQID to associate the data payload with the push write request. This matching ensures that the data payload is correctly linked to the corresponding transaction.

At operation 516, the host 120 performs the write operation associated with the push write request. The host 120 stores the data payload in memory and ensures that the write operation is globally observed.

At operation 518, the host 120 sends a completion message back to the device 110. The completion message indicates whether the write operation was successful or if an error occurred. If an error is detected, the completion message includes an error indication.

At operation 520, the device 110 receives the completion message from the host 120. The device 110 processes the completion message to determine the status of the write operation.

At operation 522, the device 110 deallocates memory and recycles the CQID and UQID. Upon receiving the completion message, the device 110 may deallocate the memory associated with the push write transaction. Recycling the CQID and UQID may involve returning these identifiers to a pool of available identifiers that can be reused for future transactions. This recycling process may help conserve resources by allowing the reuse of identifiers, potentially improving the efficiency of subsequent push write operations. The device 110 may maintain a data structure, such as a queue or list, to track available and in-use identifiers. When recycling, the device 110 may update this data structure to indicate that the CQID and UQID are now available for reuse. In some implementations, the device 110 may also perform additional cleanup operations, such as clearing any associated metadata or temporary storage related to the completed transaction.

In some examples, device control unit 112 may be further configured to determine whether the host supports the push write request by querying at least one of a Central Processing Unit Identifier (CPU ID) or a downstream port capability structure. The device control unit 112 initiates a query to the host to retrieve the CPU ID, which provides information about the host's processing capabilities and compatibility with the push write request. The CPU ID serves as an identifier for the host's central processing unit, allowing the device control unit 112 to ascertain whether the host's CPU supports the enhanced CXL.Cache protocol required for push write operations.

In addition to querying the CPU ID, the device control unit 112 may also query the downstream port capability structure. This structure contains information about the capabilities of the downstream ports connected to the host, including their ability to handle push write requests. By examining the downstream port capability structure, the device control unit 112 can determine whether the specific ports on the host are equipped to support the push write mechanism. This dual-query approach ensures that the device control unit 112 accurately assesses the host's compatibility with the push write request, thereby enabling efficient and reliable data transmission.

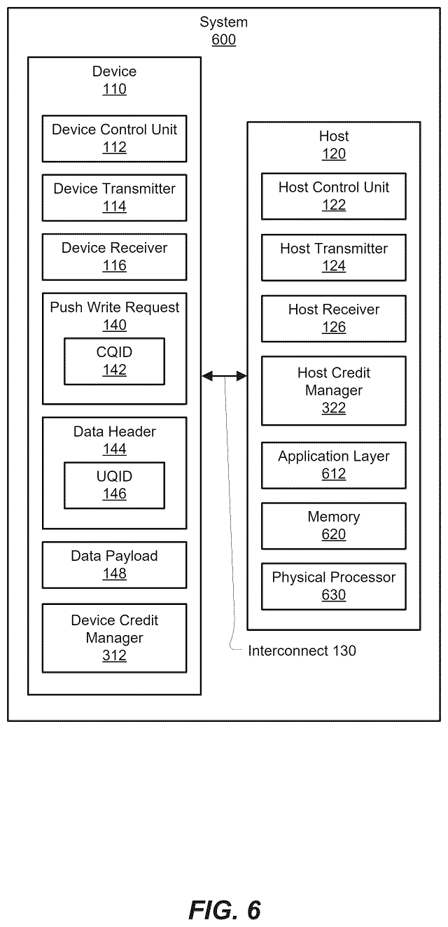

FIG. 6 illustrates a block diagram of a system 600 for implementing push write transactions. The system 600 comprises a device 110 and a host 120 interconnected by an interconnect 130, which may facilitate communication between the device and host components.

The device 110 includes several components for managing and executing push write operations. The device control unit 112 may oversee and coordinate various operations of the device. The device transmitter 114 and device receiver 116 may handle the transmission and reception of data, respectively, enabling communication with the host 120.

For push write transactions, the device 110 incorporates specific elements to manage the data transfer process. The push write request 140 contains a CQID 142, which may be used to identify and track each transaction. The data header 144 includes a UQID 146, which may be used in conjunction with the CQID to associate data payloads with their corresponding requests. The data payload 148 represents the data to be written to the host's memory.

The device credit manager 312 may play a role in implementing the credit-based flow control mechanism. This component may manage the available credits, ensuring that the device has sufficient credits before initiating a push write transaction, which may help prevent data loss and maintain reliable data delivery.

On the host side, the host 120 is equipped with components that mirror those of the device, enabling it to receive and process push write requests. The host control unit 122 may oversee the host's operations, while the host transmitter 124 and host receiver 126 handle data communication with the device 110.

The host credit manager 322 may work in conjunction with the device credit manager 312 to implement the credit-based flow control mechanism on the host side. This component may manage credit allocation and track credit usage, which may help maintain smooth data flow between the device and host.

The host 120 also includes additional components that may be involved in processing push write requests. The application layer 612 may represent the software layer where applications utilizing the push write mechanism operate. The memory 620 may serve as the storage location for received data payloads, while the physical processor 630 may execute instructions for processing push write requests and managing data storage.

The interconnect 130 serves as the communication channel between the device 110 and host 120. This interconnect may enable the transmission of push write requests, data headers, data payloads, and credit management information between the device and host components.

In operation, the system 600 may allow for efficient data transfers from the device 110 to the host 120. The push write mechanism, facilitated by the components shown in FIG. 6, may reduce the number of link traversals required for device-to-host memory writes, which may improve overall system performance for some applications.

In summary, as described above, embodiments of the present disclosure may enhance one or more protocols (e.g., the CXL.Cache protocol) to improve the efficiency and speed of device-to-host memory writes, particularly for applications that are extremely sensitive to latency, such as HFT. The proposed enhancements introduce a push write mechanism that allows a device to initiate a write request and send the data payload to the host without waiting for a command from the host. This reduces the number of link traversals required to complete the memory write transaction, thereby lowering overall latency and improving software performance.

The push write mechanism involves several key components and steps. The device generates a push write request that includes a unique CQID. This request is sent to the host, followed by a data header containing a UQID that matches the CQID. The data payload is then transmitted, and the host uses the matching identifiers to correctly associate the data with the write request. After performing the write operation and ensuring it has been globally observed, the host sends a completion message back to the device, indicating the success or failure of the write operation.

One advantage of embodiments of the present disclosure is the reduction in latency for device-to-host memory writes. By allowing the device to send data without waiting for a host command, the number of link traversals is minimized, leading to faster data processing. This is particularly beneficial for latency-sensitive applications like HFT, where rapid data processing is critical. Additionally, the use of CQID and UQID ensures data integrity, and the credit-based flow control mechanism prevents data loss and ensures reliable delivery of data payloads.

Overall, embodiments of the present disclosure may enable a meaningful performance uplift for software applications that rely on quick data transmission from the device to the host, enhancing the efficiency and speed of data center hardware and improving the overall system performance.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

1. A system comprising:
a device comprising:
a transmitter configured to send a push write request, a data header, and a data payload;
a control unit configured to:
manage a credit-based flow control mechanism to prevent data loss and ensure reliable delivery of data payloads;
validate that available credits within the credit-based flow control mechanism for the push write request and the data header before initiating a push write transaction;
initiate a push write request to a host, the push write request indicating that the device will send a data payload without waiting for a command from the host;
send:
the data header corresponding to the push write request; and
the data payload corresponding to the push write request.

2. The system of claim 1, wherein:
the device further comprises a receiver configured to receive a completion message from the host;
the control unit is further configured to:
receive the completion message from the host indicating whether a write associated with the push write request has been globally observed; and
deallocate memory associated with the push write transaction and recycle the CQID and UQID upon receiving the completion message.

3. The system of claim 1, wherein the control unit of the device is further configured to determine whether the host supports the push write request by querying at least one of a Central Processing Unit Identifier (CPU ID) or a downstream port capability structure.

4. The system of claim 1, the host comprising:
a receiver configured to receive the push write request and the data payload from the device;
a control unit configured to:
receive the data header with the UQID matching the CQID included in the push write request;
match the CQID with the UQID to associate the data payload with the push write request; and
perform a write operation associated with the push write transaction.

5. The system of claim 4, the host further comprising:
a transmitter configured to transmit a completion message to the device indicating whether a write operation associated with the push write transaction has been globally observed; and
the control unit is further configured to send the completion message to the device.

6. The system of claim 1, wherein the push write request comprises a Weakly-Ordered-Write-Invalidate-Forward request.

7. The system of claim 1, wherein the data header and the push write request are transmitted over independently credited physical channels.

8. The system of claim 1, wherein the device and the host are configured to operate in a Compute Express Link (CXL) cache protocol environment.

9. The system of claim 1, wherein the data header comprises a data header unique identifier (UQID) matching a push write request unique identifier (CQID) included in the push write request.

10. A method comprising:
managing, by a device, a credit-based flow control mechanism to prevent data loss and ensure reliable delivery of data payloads;
validating, by the device, that adequate credits are available within the credit-based flow control mechanism for a push write request and a data header before initiating a push write transaction;
initiating, by the device, the push write request to a host, the push write request indicating that the device will send a data payload without waiting for a command from the host;
sending, by the device:
the data header corresponding to the push write request; and
the data payload corresponding to the push write request.

11. The method of claim 10, further comprising receiving, by the device, a completion message from the host indicating that a write operation associated with the push write transaction has been globally observed.

12. The method of claim 11, the completion message comprising an error indication if an error condition is detected during the write operation.

13. The method of claim 11, further comprising deallocating, by the device, memory associated with the push write transaction from a transmit buffer after receiving the completion message.

14. The method of claim 10, the push write request comprising a Weakly-Ordered-Write-Invalidate-Forward request.

15. The method of claim 10, the data payload comprising a size of 64 bytes.

16. The method of claim 10, wherein the device determines whether the host supports the push write request by querying at least one of a Central Processing Unit Identifier (CPU ID) or a downstream port capability structure.

17. The method of claim 10, wherein the data header and the push write request are transmitted over independently credited physical channels.

18. A method comprising:
receiving, by a host, a push write request from a device, the push write request indicating that the device will send a data payload without waiting for a command from the host;
receiving, by the host, a data header comprising a data header unique identifier (UQID) matching a push write request unique identifier (CQID) included in the push write request;
matching, by the host, the CQID with the UQID to associate the data payload with the push write request; and
performing, by the host, a write operation associated with the push write request.

19. The method of claim 18, further comprising sending, by the host, an external completion message to the device after the write operation is globally observed.

20. The method of claim 19, wherein the external completion message includes an error indication if an error condition is detected during the write operation.
